(19) United States
(12) Patent Application Publication
(10) Pub. No.: US 2023/0090740 A1
(43) Pub. Date: Mar. 23, 2023

(54) System and Method for Predicting Arrival Time in a Freight Delivery System

(71) Applicant: PCS Software, Inc., Houston, TX (US)

(72) Inventors: Tatyana KOSTYANOVSKAYA, Houston, TX (US); Rob POORT, Spring, TX (US); Shannon POTTER, Ringwood, NJ (US); Paul BEAVERS, Fulshear, TX (US)

(73) Assignee: PCS Software, Inc., Houston, TX (US)

(21) Appl. No.: 17/815,797

(22) Filed: Jul. 28, 2022

Related U.S. Application Data
(60) Provisional application No. 63/227,898, filed on Jul. 30, 2021.
(60) Provisional application No. 63/227,873, filed on Jul. 30, 2021.

(51) Int. Cl. G06Q 10/0833; G06Q 10/04; G06Q 10/0835; G06Q 10/0834; G06Q 10/0832; G06Q 50/30

(52) U.S. Cl. CPC G06Q 10/0833; G06Q 10/04; G06Q 10/08355; G06Q 10/0834; G06Q 10/0832; G06Q 50/30

(57) ABSTRACT

Systems and methods for determining an estimated time of arrival (ETA) and/or an on-time probability (OTP) metric are provided. For example, a request for an estimated time of arrival for a first load is requested. The request may include or reference scheduled delivery data. The scheduled delivery data may include information about the load and the driver and/or equipment scheduled to deliver the load. For example, driver hours of service information for the scheduled driver may be accessed. In addition, external data may be accessed, such as traffic and weather data. A trained machine-learning ETA model may be used to provide an ETA based on the load data, the external data, and information about the scheduled driver. In addition, a trained machine-learning OTP model may be provided to estimate a probability, based on the received information, of the load being delivered within a delivery window.

### CROSS-REFERENCE TO RELATED APPLICATION(S)

This application claims priority from U.S. Provisional Patent Application No. 63/227,873, entitled “System and Method for Optimizing Backhaul Loads in a Transportation System,” filed Jul. 30, 2021, and U.S. Provisional Patent Application No. 63/227,898, entitled “System and Method for Predicting Arrival Time in a Freight Delivery System,” filed Jul. 30, 2021, which applications are hereby incorporated by reference herein for all that they teach. To the extent appropriate, a claim for priority is made to each of the above-referenced applications.

### BACKGROUND

In the transportation industry, trucks and trailers (or other delivery equipment) that move without a load are very costly to carriers. To reduce the empty miles and create operational efficiency, it is advantageous to find “backhaul” loads for drivers and trucks to haul on their return trips. Reducing or eliminating these “deadhead” miles is beneficial for carriers and for private fleets. In addition, accurate predictions of estimated time of arrival (ETA) and estimates of on-time probability (OTP) for delivery loads are useful in the transportation industry. It is with respect to this general environment that aspects of the present application are directed.

While relatively specific examples have been discussed, it should be understood that aspects of the present disclosure should not be limited to solving the specific examples identified in the background.

### SUMMARY

In nonexclusive aspects, the present application discloses a method for determining an estimated delivery time, comprising: receiving a request for an estimated-time-of-arrival (ETA) for a first load; receiving scheduled delivery data, wherein the scheduled delivery data includes, for the first load, at least carrier data, first load data, and external data, the first carrier data comprising at least driver information and driver hours of service information, the first load data comprising first load identifying information, a first load start location, and a first load end location, and the external data comprising at least traffic data and weather data; accessing a machine-learning, ETA model; estimating, using the ETA model and the scheduled delivery data, a first estimated delivery time for the first load; and providing the first estimated delivery time.

In another nonexclusive aspect, the present application discloses a system for determining an estimated delivery time, comprising: at least one processor; and memory, operatively connected to the at least one processor and storing instructions that, when executed by the at least one processor, cause the system to perform a method. In aspects, the method comprises: receiving a request for an estimated-time-of-arrival (ETA) for a first load; receiving scheduled delivery data, wherein the scheduled delivery data includes, for the first load, at least carrier data, first load data, and external data, the first carrier data comprising at least driver information and driver hours of service information, the first load data comprising first load identifying information, a first load start location, and a first load end location, and the external data comprising at least traffic data and weather data; accessing a machine-learning, ETA model; estimating, using the ETA model and the scheduled delivery data, a first estimated delivery time for the first load; and providing the first estimated delivery time.

In another nonexclusive aspect, the present application discloses a method for determining an estimated delivery time and an on-time probability metric, comprising: receiving a request for an estimated-time-of-arrival (ETA) for a first load; receiving scheduled delivery data, wherein the scheduled delivery data includes, for the first load, at least carrier data, first load data, and external data, the first carrier data comprising at least driver information and driver hours of service information, the first load data comprising first load identifying information, a first load start location, and a first load end location, and the external data comprising at least traffic data and weather data; accessing a machine-learning, ETA model; estimating, using the ETA model and the scheduled delivery data, a first estimated delivery time for the first load; providing the first estimated delivery time; accessing an on-time-probability (OTP) model; determining, based on the OTP model and the scheduled delivery data, a first estimated on-time probability (OTP) metric for the first load; providing the first estimated on-time probability metric, wherein the first estimated on-time probability metric comprises an estimated chance for the first load to be delivered within a delivery window; providing, to a client device, at least one option to improve the first estimated on-time performance metric; receiving a selection of the at least one option; and alerting an optimization system of the selection of the at least one option.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures:

FIG. 1 depicts an example transportation logistics system according to the present application.

FIG. 2 depicts an example optimization system according to the present application.

FIG. 3 depicts an example ETA/OTP system according to the present application.

FIG. 4 depicts an example method for scheduling deliveries according to the present application.

FIG. 5 depicts an example method for determining ETA/OTP according to the present application.

FIG. 6 depicts an example computing environment in which example systems and methods of the present application may be practiced.

### DETAILED DESCRIPTION

The following detailed description refers to the accompanying drawings. Wherever possible, the same reference numbers are used in the drawings and the following description to refer to the same or similar elements. While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the present disclosure, but instead, the proper scope of the present disclosure is defined by the appended claims. The following detailed description is, therefore, not to be taken in a limiting sense.

The present application discloses novel systems and methods to optimally match loads for pick up to carrier units (e.g., drivers/delivery vehicles). In examples, carriers are transportation companies that own or lease delivery vehicles (such as trucks) and deliver loads on behalf of shippers. Shippers, in examples, may be merchants or other parties that ship goods and/or other materials. In some examples, shippers may own or control a private fleet of delivery vehicles and, therefore, may act as their own carriers.

Among other advantages, the present systems and methods may reduce the number of miles delivery vehicles travel with an empty load (also referred to as deadhead miles), thereby optimizing the usage of fuel, labor, and physical assets. Additionally, reducing empty miles at scale significantly reduces the carbon footprint created by the commercial transportation industry.

Given the data available in the transportation logistics system (TLS), present systems and methods can provide carriers (including private fleet managers) with the ability to automatically identify possible loads to be hauled that are near to the delivery vehicle and driver that has recently delivered a load. In addition, present systems and method can be integrated with autonomous vehicle control systems in order to automatically control and route autonomous vehicles operating to haul loads.

In some examples, the present systems and methods include a standalone service capable of ingesting transportation data and producing recommendations and/or instructions as to where drivers and/or delivery equipment should be dispatched to pick up their next load. In some examples, a service provider may provide such delivery schedules to multiple carriers and/or shippers (collectively referred to as customers or users), and data from multiple customers may be used to optimize performance of the optimization system, while the delivery schedules themselves may be customized for the particular customer(s).

In aspects, one potential advantage is to reduce the number of deadhead/empty miles driven by carrier units (e.g., drivers and/or vehicles, such as trucks). While directly applicable to third-party carrier organizations that haul cargo for other parties, there is also potential value for shippers, private fleets (a one-party carrier), and possibly brokers. Among other things, in examples, increased fuel efficiency, decreased costs, lower environmental impact, and increased revenue may be advantages of the present systems and methods.

Further, in examples, the present optimization systems and methods may utilize data from multiple customers in order to continually improve its performance. For example, an optimization system may use artificial intelligence (AI) (including, in some examples, machine learning), along with data from a plurality of customers to derive and continually improve a model for optimizing unit/load matching in order to generate a delivery schedule. Recommended delivery schedule(s) for the fleets of individual customers may be customized based on particular parameters/constraints of the individual customers. In addition, some static filter rules may be enforced prior to presenting the available unit data and available load data to the optimization system for a recommendation and/or implementation of a delivery schedule. Such static filter rules may, in some cases, be applicable to all customers, while others may be specific to (and editable by) individual customers.

In some examples, present systems and methods may also be used to calculate an estimated time of arrival (ETA) and/or an on-time probability (OTP) for a given load. In examples, both carriers and shippers can use present systems and methods to determine an ETA for a load and the chance that the load will be delivered within a given delivery window. Using artificial intelligence (such as machine learning), models of ETA prediction and/or OTP may be created, trained, and continually improved based on historical delivery performance. In some examples, the models may be carrier-specific or shipper-specific. In some examples, models may be created or improved by historical data relevant to multiple carriers and shippers. In some examples, the ETA/OTP systems and methods may also utilize an initial, third-party ETA for a shipment that is based on simple distance and traffic data. However, the initial ETA for a load (also referred to herein as an initial estimated delivery time) may be improved and/or the OTP for such load may be calculated based on more sophisticated modeling. For example, the models may take into account a variety of factors, including factors beyond simple distance or traffic considerations, such as individual driver histories, weather, and hours-of-service requirements.

Further, a user may be given an option to change certain delivery option(s) in order to de-risk a shipment (that is—improve the OTP for the load). The change in delivery option(s) may, for example, be fed back to the optimization system to alter the matching of loads to units of delivery equipment. In some examples, the ETA/OTP system may calculate and display to a user the change in OTP (and/or ETA) that may result from the selection of the change in delivery option(s).

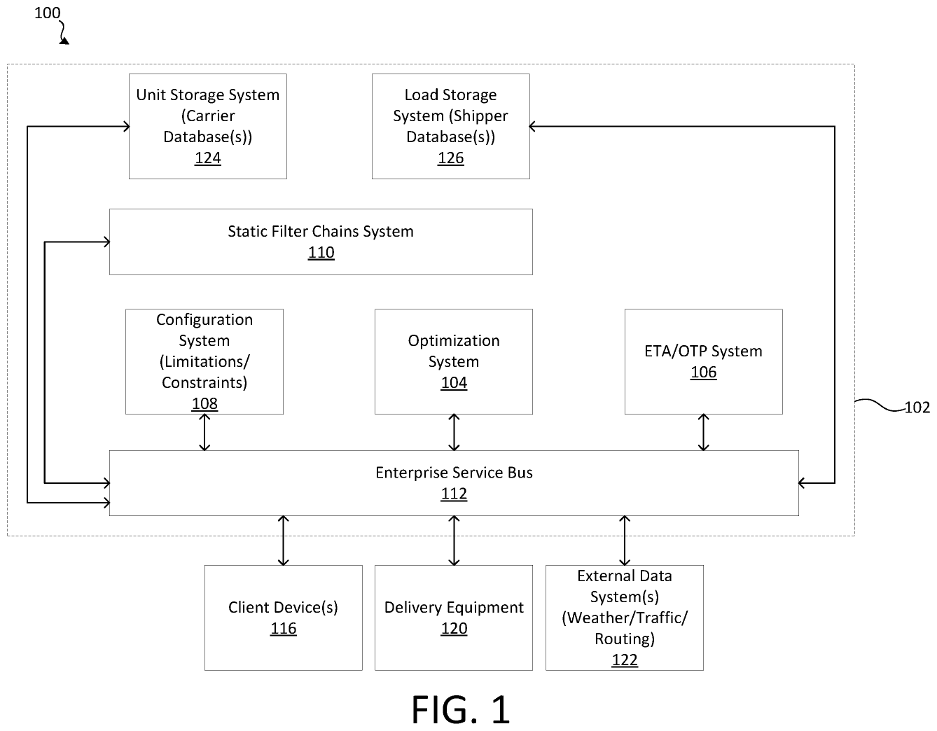

Referring to FIG. 1, a system 100 is described. In examples, transportation logistics system (TLS) 102 comprises an optimization system 104, an ETA/OTP System 106, a configuration system 108, a static filter chains system 110, unit storage system 124, and load storage system 126. TLS 102 may also comprise an enterprise service bus (ESB) 112. In examples, the ESB 112 may comprise an asynchronous bus that permits the component system(s) and application(s) of the TLS 102 to asynchronously communicate both with each other and with external systems. In examples, the use of an ESB 112 allows different components (e.g., applications) of system 100 to be decoupled from each other, e.g. by using a messaging server such as advanced message queuing protocol (AMQP) or otherwise. Data that travels on the bus may be in a canonical format, such as extensible markup language (XML). To the extent different system(s) and component(s) of the system 100 require disparate data formats, the ESB 112 may include data collectors that transform data to and from the canonical format of the ESB 112. Components of TLS 102 may also be communicatively connected (e.g., via ESB 112 or otherwise) to one or more external systems, such as client device(s) 116, delivery equipment 120, and external data system(s) 122. In other examples, the ESB 112 may be omitted, the ESB may enable synchronous communication, and/or certain components of system 100 may communicate in point-to-point fashion with each other. Any discussion herein of different components of the system 100 communicating with one another (e.g., transmitting to, providing to, exposing to, retrieving from, receiving from, obtaining from, etc.) may, in examples, include point-to-point communication, synchronous or asynchronous communication via ESB 112, and/or communication through one or more intermediate device(s) or system(s).

In examples, TLS 102 may comprise a platform managed by a provider of transportation management services for multiple carriers and multiple shippers. In examples, as used herein, any service, application, system, or component disclosed as being “managed” by a party includes internal hosting of that service, application, system, or component or hosting of that service, application, system, or component in a third-party cloud-based computing environment on behalf of that party. In other examples, TLS 102 may comprise a platform managed by a single carrier for multiple shippers, or by a single shipper for its own private fleet of delivery equipment, among other possibilities. In some examples, the TLS 102 may comprise a platform managed by a broker that connects carriers and shippers, and/or a platform to support multiple such brokers. In examples, more or fewer of the components of system 100 may be included in TLS 102. Further, some or all of the components of system 100 may be combined or separated differently from what is shown in FIG. 1 without departing from the scope of the present application.

In examples, optimization system 104 may be used to match loads to be delivered to available units. In examples, each unit may comprise one or more driver(s) and one or more pieces of delivery equipment. In examples, the driver may include a main driver and a co-driver, and the delivery equipment may include a truck and one or more trailer(s). In examples, however, the driver (and co-driver) may comprise a pilot, captain, or other operator of the delivery equipment. Also, the unit may comprise an autonomous vehicle (e.g., a vehicle implementing an automated driver function). Moreover, the delivery equipment may include other forms of transportation, such as boats, aircraft, drones, etc.

Optimization system 104 may receive a request to generate a delivery schedule. For example, a client device 116 may include a user-interface that permits a user to request a delivery schedule, e.g., by posting a request on ESB 112. In some examples, the request may be automatically and/or periodically generated by an application on client device(s) 116 or as programmed into optimization system 104. In examples, client device(s) 116 may be used by both shippers and carriers in order to make requests to, and receive responses from TLS 102. In examples where TLS 102 provides services to multiple carriers, the request may identify a particular carrier for which a delivery schedule has been requested. In examples described further herein, the optimization system 104 may access limitations and constraints applicable to the carrier from configuration system 108. Other limitations or constraints may be included in the optimization request itself. In addition, configuration system 108 may store configuration settings for particular algorithms and models used in generating a delivery schedule, as described further hereinafter. In some examples, an application or user interface operating on client device(s) 116 may allow a customer (shipper or carrier) to edit the limitations and/or constraints applicable to delivery schedule(s) produced for that customer. Optimization system 104 may also obtain unit data from unit storage system 124 and load data from load storage system 126. In examples, the unit data and load data may first be filtered by static filter chains system 110 before being acted upon by optimization system 104.

In examples, the unit storage system 124 may comprise one or more database(s) or other storage mechanisms for unit data. In some examples, the unit storage system 124 may be populated and updated by individual carrier(s) that are customers of the TLS 102. In other examples, the unit storage system 124 (and/or replicated portions of the data in unit storage system 124) may be part of the TLS 102. The unit data may comprise basic information about units, such as (for each unit): a unit identifier; a driver identifier; a co-driver identifier; expiration date(s) for the driver's and co-driver's driving license(s); a truck identifier; one or more trailer identifier(s); one or more trailer type identifier(s); a maximum weight that can be carried by a unit; a maximum amount of space of the load that can be carried by the unit, fuel range for the vehicle (or battery range for electric vehicle), charge time for an electric vehicle, and any other attributes that may assist in optimizing matching between units and loads.

In examples, the unit data may also include hours-of-service rules applicable to a driver and/or co-driver, such as: driver/co-driver status (e.g., off duty, sleeper berth, driving, on duty, etc.); driver/co-driver special status (e.g., personal conveyance, yard move, etc.); driver/co-driver break time (e.g., break time required after a certain amount of driving (such as 8 hours)); driver/co-driver shift time (e.g., maximum hours a driver and/or co-driver can work in a particular day); driver/co-driver remaining shift time (e.g., remaining shift time for a driver/co-driver); driver/co-driver shift reset (e.g., the number of hours a driver/co-driver must complete to reset his/her shift driving time); driver/co-driver available driving time (e.g., total available driving time for a driver/co-driver); driver/co-driver daily time limit (e.g., maximum number of hours that the driver/co-driver can drive in a particular day); driver/co-driver availability 6070 (e.g., available time in a 60/70 hour system for the driver/co-driver; and driver/co-driver 6070 time limit (e.g., time limit for a driver/co-driver in a weekly 60/70 cycle).

Unit data may also include certain date-time information, such as: scheduled next start date (e.g., the scheduled date of the next load); scheduled end date (e.g., the scheduled delivery date of a dispatched load); delivery ETA (e.g., the ETA of the dispatched load, as opposed to the scheduled end date); date-time restriction (e.g., the time when the driver/co-driver is required to reach his/her final destination (e.g., pickup deadline of the next load)). In some examples (as described herein), the delivery ETA may be received from, or refined by, the ETA/OTP system 106.

In examples, the unit data may also include a variety of geographical information, such as: final location city (e.g., city name of the driver's final destination); final location state (e.g., the state name of driver's final destination); final location zip (e.g., the zip code of driver's final destination); final location latitude (e.g., the latitude of driver's final destination); final location longitude (e.g., longitude of driver's final destination); the current location city (e.g., the city name of driver's actual destination); the current location state (e.g., the state name of driver's actual destination); the current location zip (e.g., the zip code of driver's actual destination); the current location latitude (e.g., the latitude of driver's actual destination); the current location longitude (e.g., the longitude of driver's actual destination); the delivery location city (e.g., the city where unit is delivering currently dispatched load); the delivery location state (e.g., the state where unit is delivering currently dispatched load); the delivery location zip (e.g., the address and/or zip code of delivery for currently dispatched load); the delivery location latitude (e.g., the latitude of the delivery for currently dispatched load); and the delivery location longitude (e.g., the longitude of the delivery for currently dispatched load).

In examples, the load storage system 126 may comprise one or more database(s) or other storage mechanisms for load data. In some examples, the load storage system 126 may be populated and updated by individual shipper(s) that are customers of the TLS 102. In other examples, the load storage system 126 (and/or replicated portions of the data in load storage system 126) may be part of the TLS 102.

In examples, load data may comprise: a load identifier, a load type (e.g., type of delivery equipment needed to carry the load); load weight, load space (e.g., the volume of space taken up by a given load); a hazardous load indicator; the city, state, zip code, longitude, and latitude of the load's starting point for the shipment; the city, state, zip code, longitude, and latitude of the load's delivery location; the pickup start date (e.g., the earliest date when the load can be picked up); the pickup deadline (e.g., the latest date the load can be picked up); the delivery start date (e.g., the earliest date when the load can be delivered at the delivery location); the delivery end date (e.g., the deadline for load delivery), and any other attributes that may assist in optimizing matching between units and loads. In examples, the pickup start date and the pickup deadline may comprise a pickup window, and the delivery start date and the delivery deadline may comprise a delivery window. Further, in examples, any date (e.g., start or end) may be expressed as a day or a particular time of day. In some examples (and particularly related to past decisions data related to educating optimization model(s) as described further herein), the load data may also include: dispatch date (e.g., exact time when load has been dispatched to a driver); deadhead miles (e.g., estimated deadhead miles for the load); unit identifier (e.g., the identifier of the unit to which the load has been assigned), and any other attributes that may assist in optimizing matching between units and loads.

In examples, the request to schedule load(s) for delivery may contain additional information, such as: a request type (e.g., whether the request is for scheduling a single delivery or for scheduling an entire fleet of units); and a time range (such as a time window for all of the loads/units to be scheduled pursuant to the request). In addition, the request may include (or cause creation of) several data matrices describing the relative locations of, and distances between and among, units and loads. In examples, such distance matrices may be generated by one or more components of system 102 from unit data and load data in unit storage system 124 and load storage system 126, or may be obtained from an external data source, such as external data system(s) 122. Example distance matrices are discussed below.

The distance matrices may be completed with the lengths (distances) of the route(s) between two points. A first example matrix may correspond to a driver-load matrix. For example, that matrix may have a matrix of size of (2*n_drivers+n_loads)×n_loads, created by concatenating three submatrices: (a) first submatrix, (n_drivers×n_loads), corresponds to distances between starting position of drivers and starting positions of loads; (b) second submatrix, (n_loads×n_loads) (not symmetric): (i) the diagonal comprises of distances between starts and ends of the same load, namely: dist(load_1_start, load_1_end); (ii) above the diagonal there are distances between ends and starts of pairs of loads, e.g., dist(load_1_end, load_2_start); and (iii) below the diagonal there are distances between starts and ends of pairs, e.g dist(load_2_end, load_1_start), and (c) third submatrix, (n_drivers×n_loads), corresponds to distances between end position of drivers and end positions of loads. A second example matrix may comprise a driver-driver matrix. For example, that matrix may have a matrix size of n_drivers×n_drivers, which comprises of distances between drivers start and end positions.

One example of the driver-load matrix is illustrated below:

TABLE 1

| | | load_1 | load_2 | load_3 |
|---|---|---|---|---|
| First | driver_1 | dist(driver_1_start, | dist(driver_1_start, | dist(driver_1 _start, |
| Submatrix | | load_1 _start) | load_2_start) | load_3_start) |
| | driver_2 | dist(driver_2_start, | dist(driver_2_start, | dist(driver_2_start, |
| | | load_1 _start) | load_2_start) | load_3_start) |
| Second | load_1 | dist(load_1_start, | dist(load_1_end, | dist(load_1_end, |
| Submatrix | | load_1_end) | load_2_start) | load_3_start) |
| | load_2 | dist(load_2_end, | dist(load_2_start, | dist(load_2_end, |
| | | load_1 _start) | load_2_end) | load_3_start) |
| | load_3 | dist(load_3_end, | dist(load_3_end, | dist(load_3_start, |
| | | load_1 _start) | load_2_start) | load_3_end) |
| Third | driver_1 | dist(driver_1_end, | dist(driver_1_end, | dist(driver_1_end, |
| Submatrix | | load_1_end) | load_2_end) | load_3_end) |
| | driver_2 | dist(driver_2_end, | dist(driver_2_end, | dist(driver_2_end, |
| | | load_1_end) | load_2_end) | load_3_end) |

An example of the driver-driver matrix (for three drivers) is illustrated below in Table 2:

TABLE 2

| | driver_1 | driver_2 | driver_3 |
|---|---|---|---|
| driver_1 | dist(driver_1_start, | | |
| | drive_1_end) | | |
| driver_2 | | dist(driver_2_start, | |
| | | driver_2_end) | |
| driver_3 | | | dist(driver_3_start, |
| | | | driver_3_end) |

In some examples, time matrices may also be employed. Similar to the distance matrices, the optimization system 104 may also accept times, defined as “time needed to move from one load to another.” If the optimization system 104 is configured, for example, to take into account time for drivers being flown or taking trains between a destination location and a next pickup location, those can be used as such and the distance matrices may then be redefined as “deadhead when moving drivers from X to Y.”

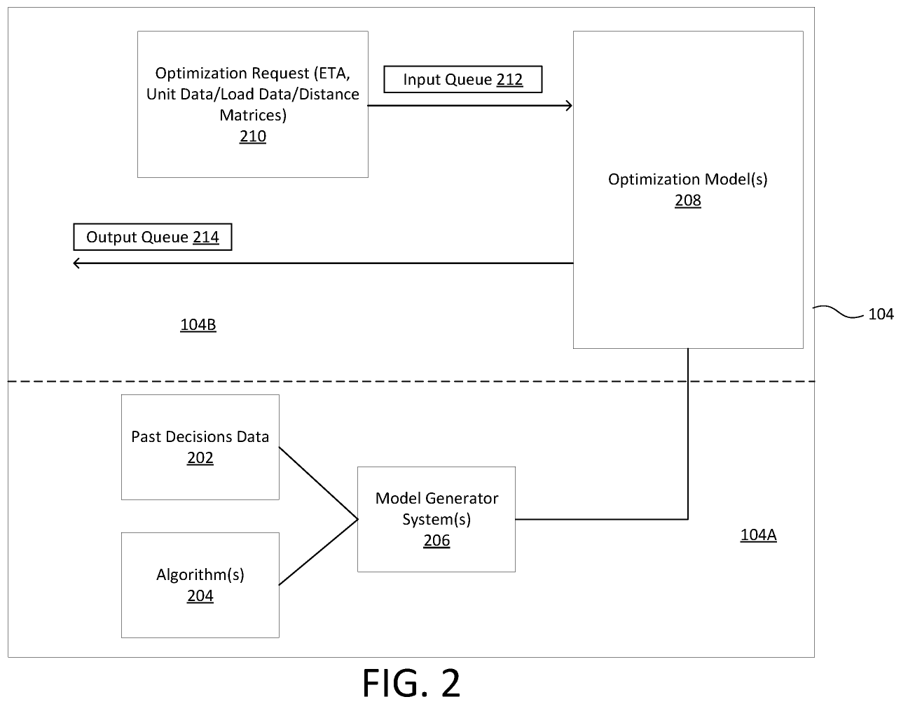

A nonexclusive example of an optimization system 104 is depicted in FIG. 2. In examples, optimization system 104 is designed to provide a best possible allocation of loads to units in order to minimize deadhead miles (e.g., defined as the distance that units travel without carrying a load). In examples, in addition to minimizing deadhead miles, optimization system 104 may be designed also to provide a best possible allocation of loads to units in order to maximize driver usage (e.g., a number of loads per driver). In some examples, the optimization system 104 may be optimized to reduce deadhead miles and/or maximize driver usage while also balancing other considerations, such as limitations/constraints (e.g., as provided by configuration system 108), reducing overall cost to the customer, or otherwise.

The example optimization system 104 may include a modeling system 104A and an inference system 104B. The modeling system 104A may comprise one or more past decisions data storage system(s) 202 and one or more algorithm storage system(s) 204, both of which are operatively connected to model generator system(s) 206. In examples, past decisions data storage system(s) 202 may comprise one or both of unit storage system(s) 124 and load storage system(s) 126; or past decisions data employed by modeling system 104A may comprise separate database(s) or other storage. Further, algorithm storage system(s) 204 may comprise memory of one or more device(s) implementing model generator system(s) 206.

In examples, the model generator system(s) 206 may comprise blob storage, a machine-learning platform, and a container registry, which may cooperate to produce and refine trained model(s) for one or more algorithms used to generate a delivery schedule. For example, a trained optimization model may be deployed in a container to optimization model(s) system 208 and used to generate delivery schedule(s) by inference system 104B. In other examples, optimization model(s) may be deployed using serverless computing techniques.

In examples, an image used for deploying the container may be built by using a base image containing all of the required dependencies (which image may be created and uploaded to the optimization model(s) system 208 at the infrastructure deployment stage) along with an optimization model trained on the machine learning platform (such as Azure machine learning platform). In other examples, the optimization model(s) may be deployed without a container using serverless computing techniques.

Past decisions data may include data that is specific to a particular customer or data that is from multiple customers that is available to optimization system 104. In examples, past decisions data may include data regarding decisions made by a customer of the optimization system 104 when a proposed delivery schedule is provided by optimization system 104 (e.g., was the schedule accepted, and, if not, what changes were made or requested by the user) Past decisions data may be used to educate or retrain individual machine-learning optimization model(s) for one or more algorithms. That is, the optimization model(s) may be attend/supervised and retrained using labeled past decisions data. Potential sample algorithms to use in generating delivery schedules are discussed below.

A first example algorithm is a holistic annealer algorithm. In examples, a form of an optimization method known as simulated annealing may be used. Simulated annealing is generally used for non-differentiable optimization problems. For example, in a metallurgical process of annealing—having the initial temperature T=Tmax, each step is cooled to T=Tmin, while simultaneously allowing less temporal increase of optimized function (energy). Simulated annealing is especially suitable when computational time constraints matter, while an approximate solution is considered good enough and therefore preferred to searching for an exact optimum. In examples, this algorithm is capable of solving discrete-space optimization issues and has been previously applied for route planning tasks (e.g., the travelling salesman problem).

Present systems include a holistic approach to the deadhead reduction problem using simulated annealing. For example, the presently disclosed holistic annealing algorithm may optimize the whole system (assignments of all or multiple units to multiple loads for a given time frame and/or customer) at once, contrary to a greedy approach of iteratively choosing a load for a unit or a set of units.

In examples, the holistic annealing algorithm works by cultivating and mutating a solution. In examples, a solution is a set of assignments and orders of loads for each unit. This may also be referred to herein as a delivery schedule.

In examples, there are four types of mutation that may govern the behavior of the holistic annealing algorithm: (a) assigning a single load to the unit, governed by assign_probability—where a load is randomly assigned to a random unit; (b) unassigning a single load from the unit, governed by unassign_probability—where a load is randomly picked to be unassigned from a random unit; (c) reassigning a single load to the unit, governed by reassign_one_probability—which may comprise a combination of (a) and (b); and (d) reassigning many loads, governed by reassign_many_probability—where parts of the load sequences are swapped between two units.

In examples, each of those mutations can be executed independently depending on the defined probabilities (assign_probability, reassign_one_probability, etc.). During each of those steps, it may be determined whether a load is allowed to be taken by a particular unit. Also, with each change in load-unit assignments, the resulting changes in overall deadhead miles of the system may be determined.

As the “energy” function (for the purposes of the annealing analogy), the actual deadhead of the whole system may be used, along with three defined penalties for: (a) unassigned_load_penalty—defined as a product of the number of unassigned loads and the unassigned_load_penalty parameter; (b) unassigned unit penalty—defined as a product of the number of units without any loads and unassigned_driver_penalty parameter; and (c) long routes penalty—defined as a product of route_length_penalty_multiplier and a sum of lengths of routes raised to the power of route_length_penalty_exponent (e.g., the longer the route, the bigger the penalty so it forces the algorithm to distribute the loads more uniformly).

Another example algorithm that may be employed is linear programming. In examples, linear programming is an optimization method that finds the minimum of some goal function under a given set of constraints. In its case, both the goal function and the constraints have to be expressed as linear in regard to a set of decision variables. Thanks to its linearity, such a problem can be solved using well-defined mathematical methods—in this case, the simplex algorithm. It can be proven that if a minimum of the function exists, the algorithm will find it.

An example of a potential linear programming function is discussed below. In this example, the following constants are defined: driver_index—set of driver identifiers; load_index—set of load identifiers; dist_start_start—indexed by (driver, load) pairs, distance between current location of the driver's and the load's pickup location; dist_end_end—indexed by (driver, load) pairs, distance between load's delivery location and the driver's base (final) location; dist_start_end_driver—indexed by driver ids, distance between driver's current location and driver's base location; Is_match_disallowed—indexed by (driver, load) pairs, equals to 0 if and only if the set of filters (e.g., in static filter chains system 110) allows for matching driver to load; load_count—number of all loads; and dist_end_start—indexed by (load1, load2) pairs, distance between load1's delivery location and load2's pickup location.

Continuing with the above example, the following variables may be defined: matched[driver, load]—decision binary variable indexed by (driver, load) pairs, equals to 1 if and only if the algorithm decides that the driver should carry the load; first[driver, load]—binary variable indexed by (driver, load) pairs, equals to 1 if and only if the driver carries the load as its first load; last[driver, load]—binary variable indexed by (driver, load) pairs, equals to 1 if and only if the driver carries the load as its last load; l[load1, load2]—binary variable indexed by (load1, load2) pairs, equals to 1 if and only if load2 is carried directly after load1 by the same driver; and no_cycle—indexed by load ids, it is used to prevent cycle creation in the values of the above variable l.

Continuing with the above example, objective function may be defined by:

$${\sum }_{drivers , loads} first [ driver , load ] \cdot dist\_start \_ start [ driver , load ] + {\sum }_{drivers , loads} last [ driver , load ] \cdot dist\_end \_end [ driver , load ] + {\sum }_{drivers} ( 1 - {\sum }_{loads} first [ driver , load ] ) \cdot dist\_start \_end \_driver [ driver ] + {\sum }_{loads , loads} 1 [ load 1 , load 2 ] \cdot dist\_end \_start \_loads [ load 1 , load 2 ]$$

In addition, the assignment of every load can be enforced by passing the flag force_match=True, then the objective function is defined as set forth below, where penalty constant is determined on a per-optimization-request basis:

$${\sum }_{drivers , loads} first [ driver , load ] \cdot dist\_start \_start [ driver , load ] + {\sum }_{drivers , loads} last [ driver , load ] \cdot dist\_end \_end [ driver , load ] + {\sum }_{drivers} ( 1 - {\sum }_{loads} first [ driver , load ] ) \cdot penalty\_constant + {\sum }_{loads , loads} 1 [ load 1 , load 2 ] \cdot dist\_end \_start \_loads [ load 1 , load 2 ]$$

Continuing with the above example, constraints may be stored in (and accessed from) configuration system 108 and may be defined by:
1. FilterMatchesConstraint—which guarantees that a disallowed (by filters) match will not be connected;

$${\sum }_{drivers , loads} is\_match \_disallowed [ driver , load ] \cdot matched [ driver , load ] == 0$$

2. OneFirstLoadConstraint—which guarantees that every driver has at most 1 first load;

$${\sum }_{loads} first [ driver , load ] ⩽ 1$$

3. FirstlfflastLoadConstraint—which guarantees that every driver has a first load if and only if he has a last load;

$${\sum }_{loads} first [ driver , load ] = {\sum }_{loads} last [ driver , load ]$$

4. LoadFirstOnceConstraint—which guarantees that every load is first for at most one driver or is after at most one load;

$${\sum }_{drivers} first [ driver , load ] + {\sum }_{load 2 : loads} 1 [ load 2 , load ] ⩽ 1$$

5. Load LastOnceConstraint—which, similar to the above constraint, guarantees that every load is last for at most one driver or is before at most one load;

$${\sum }_{drivers} last [ driver , load ] + {\sum }_{load 2 : loads} 1 [ load , load 2 ] ⩽ 1$$

6. CycleEliminationConstraint—which, for every pair of load1 and load2, enforces that consecutive loads will have an increasing value of no_cycle variable;

no_cycle[load1]−no_cycle[load2]+load_count·l[load1,load2]≤load_count−1
7. LoadBeforeAnotherConstraint—which guarantees that if some load is before another one, then it is either the first load or the other load is preceding it;

$${\sum }_{drivers} first [ driver , load ] + {\sum }_{load 2 : loads} 1 [ load 2 , load ] ⩾ {\sum }_{load 2 : loads} 1 [ load , load 2 ]$$

8. LoadAfterAnotherConstraint—guarantees that if some load is after another one, then it is either the last load or the other load is following it

$${\sum }_{drivers} last [ driver , load ] + {\sum }_{load 2 : loads} 1 [ load , load 2 ] ⩾ {\sum }_{load 2 : loads} 1 [ load 2 , load ]$$

9. FirstLoadBehindConstraint—which guarantees that if some load is the first load of a particular driver, then it is either followed by another load or is the last load for this driver;

$$last [ driver , load ] + {\sum }_{load 2 : loads} 1 [ load , load 2 ] \qquad ⩾ \qquad first [ driver , load ]$$

10. LastLoadBeforeConstraint—which guarantees that if some load is the last load of a particular driver, then it is either preceded by another load or is the first load for this driver;

$$first [ driver , load ] + {\sum }_{load 2 : loads} 1 [ load 2 , load ] \qquad ⩾ \qquad last [ driver , load ]$$

11. FirstLoadMatched—which guarantees that first load of each driver is matched to that driver;

first[driver,load]≤matched[driver,load]
12. LastLoadMatched—which guarantees that last load of each driver is matched to that driver;

last[driver,load]≤matched[driver,load]
13. ConsecutiveLoadsLeft—which is the first of two constraints that guarantee that consecutive loads are assigned to the same driver;

(−1)·(1−l[load1,load2])≤matched[driver,load1]−matched[driver,load2]
14. ConsecutiveLoadsRight—which is the second of two constraints that guarantee that consecutive loads are assigned to the same driver;

1−l[load1,load2]≥matched[driver,load1]−matched[driver,load2]
15. OneDriverMatched—which guarantees that each load can be matched to at most one driver.

$${\sum }_{drivers} matched [ driver , load ] ⩽ 1$$

In examples, models for one or more of the holistic annealer algorithm and/or linear programming algorithm may be trained by model generator system(s) 206 and provided to optimization model(s) system 208. Due to the nature of the problem solved by optimization system 104 (non-differentiable optimization), the training process may not be based on gradient descent or full model retraining, but rather on optimizing the accuracy and speed of the algorithms based on the prior dispatch queries (using optimization methods such as step optimization and hyper-parameter search, which may be part of an artificial intelligence/machine-learning ecosystem supported by model generator system(s) 206 and/or optimization model(s) system 208). In examples, the optimization model(s) may comprise attended/supervised models that may be periodically educated using labeled past decisions data from past decisions data storage system 202. In other examples, unattended/unsupervised learning optimization model(s) may be used and may be trained based on historical data.

The solutions may use a wide array of parameters and hyper-parameters, performance of which with use of historical data should be monitored, tested and adjusted, naturally creating a training pipeline. For example, trainable parameters in holistic annealer algorithm may include (according to the annealing analogy): t_max—maximal temperature for annealing; (b) t_min—minimal temperature for annealing; reannealings—count of annealing retries during algorithm run (the steps of the algorithm are divided equally for each try); assign_probability—probability of assigning load to the unit; reassign_one_probability—probability of retrying to assign one load from the route; reassign_many_probablitiy—probability of retrying to assign many loads from the routes to obtain better result; unassign_probability—probability of unassigning route from the unit. In examples, the individual trainable probabilities may be later scaled so they sum up to 1.

A variety of metrics may be used to evaluate the quality of a particular solution, such as deadhead miles, good miles, percentage of deadhead miles to total miles covered, late routes, an unassigned loads percentage, driver usage metrics, or otherwise. Optimization models may be periodically educated by using updated past decisions data in an attended, machine-learning model.

In examples, the unit data and the load data may also be filtered by static filter chains system 110 prior to being provided to an optimization model. For example, data filters may be defined that do not depend on unit or load location. In examples, these may include: LoadType Filter—checks if the type of unassigned load matches the delivery equipment properties; WeightFilter—checks if the weight of the load does not exceed the maximum permitted weight assigned to the unit; VolumeFilter—checks if the load volume does not exceed the maximum volume assigned to the unit; and HazardousFilter—checks if the unit has license for the hazardous material transport and that it will not expire before completion of delivery. Other filters are possible and contemplated.

Additional route acceptability checks may also be performed as part of process by which inference system 1046 produces a delivery schedule. For example, with the holistic annealer algorithm described above, it is determined whether the proposed delivery schedule satisfies all of the timeframes—that is, whether the unit will be able to pick up and deliver all the loads from an assigned route. In addition, arriving early may be taken into account so that the unit will have to wait for the delivery. This may be calculated using the estimated driving time for each part of the route based on the average speed(s) of units, or from an ETA calculated by ETA/OTP system 106. Furthermore, HOS unit rules may be accounted for in the optimization process(es).

The trained model(s) can then be used by inference system 104B to generate a delivery schedule. For example, the inference system 104B may receive an optimization request 210 on input queue 212. The request may include, or cause the inference system 104B to obtain, unit data and load data from unit storage system 124 and load storage system 126, as previously described. In examples, the unit data and load data may be filtered by static filter chains system 110, as previously described, prior to being provided to inference system 104B. In examples, in response to the request for a delivery schedule, the inference system may use the trained models of optimization model(s) system 208 to solve for a delivery schedule that minimizes deadhead miles and/or maximizes driver usage.

For example, a fleet deadhead reduction problem may be formulated as follows: there is a set T of units with corresponding information about their time availability (that is, when the unit(s) can pick up a load) and respective geographical coordinates. Also, there is a set L of loads that need to be delivered within the proper time interval and from the starting point to the destination. Deadhead miles (also called empty miles) may be defined as the miles when the unit is not carrying a load (e.g., units can be between consecutive load locations or between a load and a destination point). Further, driver usage optimization may be defined as maximizing the number of loads per day (or week, or month, or other time period) that each driver delivers. Thus, the model(s) stored and utilized by optimization model(s) system 208 may be trained (and retrained) to minimize deadhead miles and/or maximize driver usage by finding the best possible matching of loads to the units.

In some examples, the optimization model(s) system 208 may also consume certain external data as input to the optimization model(s). For example, the optimization model(s) may receive and utilize a separately calculated ETA in determining whether a particular unit can travel a particular route and still pickup all assigned loads within a pickup window and deliver all assigned loads in a delivery window. In some examples, the ETA is simply calculated based on distances between unit location(s) and load location(s), along with an assumed average speed. In some examples, the ETA is provided by a third-party system (e.g., external data system(s) 122), which may provide an initial ETA for a particular route (or between particular points on a proposed route). In examples, such third-party system(s) (such as mapping/routing systems) may take into account historical or real-time traffic information, along with distance(s). However, system 100 may also utilize a more refined ETA calculation, such as that provided by ETA/OTP system 106, as described further herein.

In examples, all models may be subject to certain limitations, which may be implemented as configuration file(s) in configuration system 108. In some examples, configuration system 108 may comprise part of blob storage in model generator system(s) 206. In example limitations: a destination point must be provided for the unit to reach (such as a home or pickup location booked in advance); a date-time restriction of reaching the destination point must be provided (such as a pickup deadline for the next load, a time when the driver needs to be back home, etc.); and a time limit for the unit must be used (such as the expiration of the driver's driving license). Further, as a global example limitation, a particular load may be assigned only to one unit and each unit may be assigned only with loads that meet its limitations (e.g., weight, volume, allowed, load type, etc.). Other limitations are possible and contemplated.

When the delivery schedule is produced by the applicable model(s) in optimization model(s) system 208, the delivery schedule (solution) may be output on output queue 214. For example, the delivery schedule may be output to client device 116, where it may be displayed and/or presented for approval by a user. In other examples, the delivery schedule may cause optimization system 104 to provide instructions directly to delivery equipment 120 (e.g., if delivery equipment 120 is an autonomous vehicle, or includes a navigation system that can directly receive directions/instructions for the unit(s) to travel particular route(s) and pickup specified load(s)).

In some examples, the inference system 104B may return an initial delivery schedule; however, the inference system 104B may be requested to provide an updated delivery schedule based on changes to certain carrier information and/or optimization criteria. For example, if a user of the client device 116 determines that the initial delivery schedule is unacceptable for some reason (e.g., a one-off preference that a particular unit be assigned to a particular load), the inference system may receive instructions to calculate an updated delivery schedule while respecting the particular instruction to change the optimization criteria, carrier information and/or assignment of a load to a unit. In examples, the change instructions may also affect the overall deadhead miles of the system or driver usage, so the unit data and load data may be re-submitted to the inference system 1046, but with the directed change causing a definitive match of the particular unit and load or changing the optimization criteria, as necessary.

Further, as described hereinafter, the initial delivery schedule may result in a user receiving notification, e.g., at a client device 116, that its load(s) will be delivered by a particular unit and/or along a particular assigned route. The ETA/OTP system 106 may calculate an OTP for the load(s) based on such assignment(s) in the initial delivery schedule. As described further below, the user may be provided with one or more option(s) to de-risk the shipment of the load(s) by, e.g., submitting requested change(s) to the carrier information, the delivery schedule, or otherwise. As such, the optimization system 104 may be requested to recalculate an updated delivery schedule accordingly.

In examples, ETA/OTP system 106 may be configured to provide an ETA and/or an OTP for delivery of a load. In some examples, ETA/OTP system 106 may receive a request for an ETA or OTP from optimization system 104. In other examples, ETA/OTP system 106 may receive a request for an ETA or OTP from a client device 116. Further, in some examples, the ETA/OTP system may receive an initial ETA and/or OTP from a third-party provider (e.g., from external data system(s) 122) and refine the ETA and/or OTP based on trained model(s). In some examples, the ETA/OTP system 106 may also provide an OTP along with one or more options to de-risk the shipment of the loads and increase the OTP and/or change the ETA.

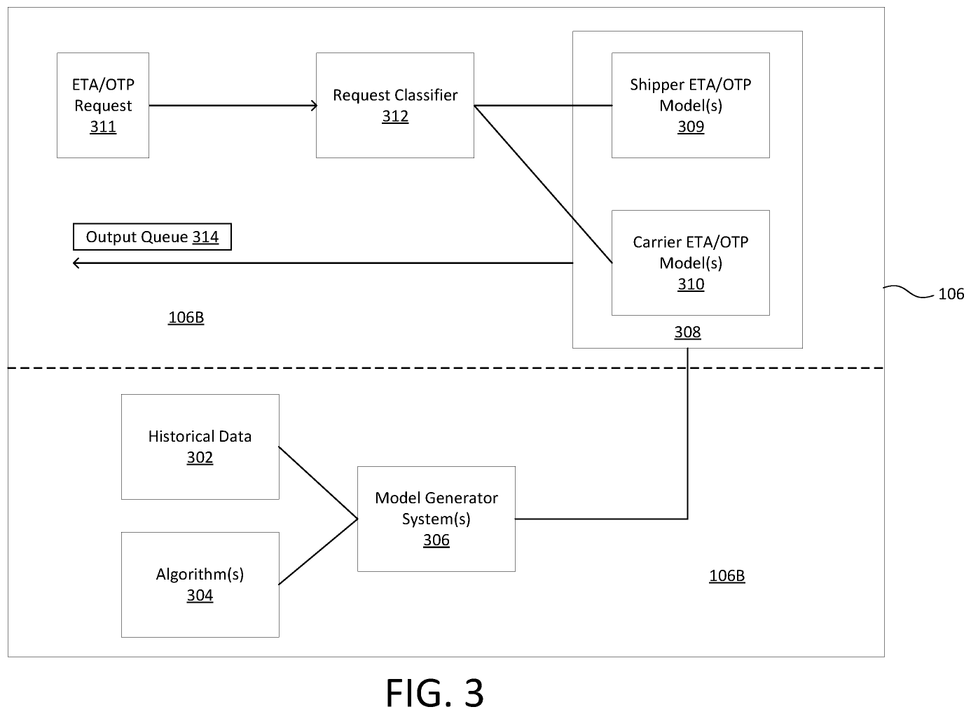

FIG. 3 depicts a non-exclusive example of ETA/OTP system 106. The example ETA/OTP system 106 may include a training system 106A and an inference system 106B. The training system 106A may comprise one or more historical data storage system(s) 302 and one or more algorithm storage system(s) 304, both of which are operatively connected to model generator system(s) 306. In examples, historical data storage system(s) 302 may comprise one or both of unit storage system(s) 124 and load storage system(s) 126, or historical data employed by training system 106A may comprise separate database(s) or other storage. Further, algorithm storage system(s) 304 may comprise memory of one or more device(s) implementing model generator system(s) 306.

In examples, the model generator system(s) 306 may comprise blob storage, a machine-learning platform, and a container registry, which may cooperate to produce and refine trained model(s) used to generate an ETA and/or OTP for a given load. For example, a trained ETA or OTP model may be deployed in a container to ETA/OTP model(s) system 308 and used to generate an ETA and/or OTP by inference system 1066. In other examples, the ETA or OTP model may be deployed without a container using serverless computing techniques. In examples, the ETA and/or OTP model(s) may be trained using the historical data on a machine learning platform (such as Azure machine learning platform).

Historical data used for training the ETA and OTP model(s) may be contained in blob storage and a container registry. The training data may be accessible in the model generator system(s) in the form of datastores and datasets, while container registry images may be accessed through a command line interface. In other examples, the ETA or OTP model may be deployed without a container using serverless computing techniques.

Historical data may include data that is specific to a particular customer or data that is from multiple customers that is available to ETA/OTP system 106. Historical data may be used to train (and retrain/continually improve) machine-learning ETA and/or OTP models for all shippers, for all carriers, or for individual shippers and carriers. In the example shown, the ETA/OTP model(s) system 308 maintains separate model(s) for shippers 309 versus models for carriers 310.

In some examples, historical data may need to be enriched. For example, presently disclosed algorithm(s) for determining ETA and/or OTP may start with an initial ETA that was produced by a third-party service (such as a mapping/routing service) using distances between points and, potentially, predicted traffic for the assigned route. In examples, the presently disclosed systems and methods may refine such an initial ETA based on a variety of unit data, load data, and external data, such as, without limitation, weather, delivery equipment information (such as information about a particular tuck/trailer combination), individual driver styles, etc. As such, if historical data received from unit storage system 124 and/or load storage system 126 (and/or elsewhere) does not contain all of the information relevant to a model, the historical data may be enriched by model generator system(s) 306.

For example, historical data may be enriched in blob storage of model generator system(s) 306 with weather data (e.g., precipitation, wind, visibility, temperature) based on the known location of the delivery equipment at different timestamps during previously traveled routes. The historical data can also be enriched with information about hours of service rules for drivers. Also, the actual travel times provided in the historical data may be enriched with an estimated ETA from a third-party service. That is, an initial estimated ETA from the third-party service, if known, may be included in the historical data. Otherwise, the initial estimated ETA from the third-party service may be generated based on the known distance (and potentially traffic) data that would have been available before the trip(s) represented by such historical data.

The historical data can then be filtered, preprocessed, and featurized for training purposes. For example, filters may be applied to eliminate incorrect data or data that is inconsistent with the inference (e.g., where the driver may have broken the law), such as eliminating data for: (a) extremely short trips; (b) trips where the average speed is too slow; (c) trips where the driver arrives at the location but waits at the end point (artificially extending the ETA); (d) trips where the driver exceeded the speed limit or otherwise broke the law; (e) trips where the driver apparently went off route or got lost; (f) trips where GPS pings were missing (making it difficult to determine accurate information at way points along the route. Other filters are possible and contemplated.

Further, the historical data may be preprocessed for multi-stop trips. If a route for a unit involves multiple stops, it may be divided into a series of two-stop trips. For every single stop trip, the data may be preprocessed, and features are extracted used by the model, which then calculates the ETA. In a last step the results are summed for the final prediction. Optionally, an additional time constant related to unloading time may be added for every stop on the route (30 min). In examples, weather data may be used only for the stops in close proximity to actual position of the delivery equipment and the features based on driver's shift are recalculated for every stop using the known or presumed HOS rules.

Among other things, the historical data can be featurized based on GPS pings recorded from the delivery equipment. For example, hours of service rules for drivers in historical databases may not be exactly known, but GPS pings can be used to infer hours of service rules that were then applicable to the driver. For example, if there are no location changes between GPS pings, it may be assumed that the driver was resting due to hours of service rules.

In examples, ETA models may comprise a regression machine-learning model. Historical data may be fed to a feedforward neural network (among other options) to produce an ETA for a load. The model(s) may be trained to predict continuous values using observed data. The true value that a model was trained to predict may be calculated as the actual time difference (in hours) between the beginning and the end of the trip.

In examples, an OTP model may comprise a random forest classifier model (among other options). Historical data may be fed to the random forest classifier to produce a result. In examples, a binary classifier is used having two classes: “delay” and “on-time.” To estimate the probability, a subclass of classifiers may return the confidence score of the model. In a last step of training, the model's confidence score may be calibrated to calculate the probability. In some examples, the following assumptions may be made: (a) arrivals before the start of, and during, the delivery window are considered “on-time”; (b) where the historical data contains only an initial ETA (and not a delivery window), the delivery window may be assumed to be a set time (e.g., one hour or twenty-four hours, etc.) for the purposes of classifying “delay” versus “on-time.” In examples, all ETA and OTP models may be subject to certain limitations, which may be implemented, e.g., as configuration file(s) in configuration system 108. In some examples, configuration system 108 may comprise part of blob storage in model generator system(s) 306.

The ETA and OTP trained model(s) can then be used by inference system 1066 to generate ETA(s) and/or OTP(s). For example, the inference system 1066 may receive an ETA or OTP request 311 at a request classifier 312. The request classifier 312 may comprise a service bus that splits ETA/OTP requests from shippers versus from carriers. E.g., a request from a shipper may be routed to a queue on which shipper ETA/OTP model(s) 309 are listening and respond, whereas a request from a carrier may be routed to a queue on which carrier ETA/OTP model(s) 310 are listening. In examples, the ETA and/or OTP request may identify the customer, which will allow the request classifier 312 to identify the customer as a shipper or a carrier, and allow the inference system 106B to limit any responses to the units and loads relevant to that customer. If different models are maintained for individual shippers and/or individual carriers, then requests may be further classified and directed to the appropriate model for such shipper and/or carrier. In other examples, only one ETA and/or OTP model is maintained, and all ETA or OTP requests 311 are processed the same, regardless of whether it is from a shipper or carrier.

Receipt of the request 311 may include, or cause the inference system 1066 to obtain, data about the scheduled delivery of a load. In examples, the scheduled delivery data may comprise load identifying information, load start location, load end location, a delivery window, and carrier data. The carrier data may, for example, include identification of a carrier currently assigned to the load (e.g., if a customer is querying ETA/OTP for multiple carriers), scheduled delivery equipment, scheduled driver(s), a scheduled number of stops for the delivery equipment (e.g., on the day(s) of scheduled delivery of the particular load), location of the scheduled stops for the currently scheduled delivery equipment, and driver hours of service information. In some examples, the scheduled delivery data may be received from the optimization system 104.

In examples, the ETA/OTP request 311 may also include, or cause the inference system 106B to obtain, external data, e.g., from external data system(s) 122. For example, the ETA/OTA model(s) system 308 may obtain and utilize predicted weather and traffic data for the scheduled route for the load. The ETA/OTA model(s) system 308 may also receive an initial ETA and/or OTP from a third-party provider (e.g., from external data system(s) 122) and refine the ETA and/or OTP based on trained model(s). For example, the initial estimated delivery time may be based (as calculated by a third-party source) on distance, mapped route, and/or traffic information. However, the initial ETA for a load (also referred to herein as an initial estimated delivery time) may be improved and/or the OTP for such load may be calculated based on more sophisticated modeling. For example, the ETA/OTP models may take into account a variety of factors, including factors beyond simple distance or traffic considerations, such as individual driver histories, weather, and hours-of-service requirements. Alternatively, no initial estimated delivery time is provided by a third party, and the ETA/OTA system 106 may calculate the ETA itself and/or based on information received from optimization system 104.

In examples, in response to the request for ETA and/or OTP, the inference system 106B may use the trained models of ETA/OTP model(s) system 308 to determine an ETA and an OTP for the currently scheduled unit/load combination and scheduled route. In examples, ETA may be expressed as a day, a time, or otherwise. The OTP may be expressed as an estimated on-time probability metric, indicating a probability that the load will be delivered within (or before) an applicable delivery window. The OTP metric may be a percentage; however, other example expressions of an OTP metric are also possible, such as a confidence score, a fraction, a decimal, or other expressions, mathematical or visual.

As a non-exclusive example, the ETA/OTP model(s) may be able to produce sophisticated ETA and/or OTP calculations based on hours of service requirements and external data. For example, assume that a unit (including a driver) is scheduled to pick up load 1 in Houston at 8:00 a.m., deliver load 1 to Austin, pickup load 2 in Austin, deliver load 2 to Dallas, pickup load 3 in Dallas, and deliver load 3 to Fort Worth. ETA/OTP model(s) system 308 receives an ETA/OTP request for load 3. The ETA/OTP model(s) system 308 further receives a scheduled delivery window for load 3 of 3:00 p.m. to 9:00 p.m., and an initial ETA for load 3 (calculated by a third-party system based only on distance/speed/traffic information for all the scheduled legs of the route) of 4:00 p.m.

In this example, the ETA/OTP model(s) system 308 also receives predicted weather information for the approximate times the unit is scheduled to be in Houston, Austin, Dallas, and Fort Worth. On that day, assume that Dallas is predicted to have severe thunderstorms for 4 hours during the scheduled drop off/pickup in Dallas. The ETA/OTP model(s) system 308 further receives driver hours of service information indicating that the driver is permitted only 10 hours of driving that day (e.g., must be finished driving by 6:00 p.m. that evening).

In examples, the ETA/OTP model(s) system 308 may revise the initial ETA based on the predicted weather, historical driver performance, and/or the driver hours of service information. For example, the ETA model may account for (based on historical information used to train the model) the historical performance of the scheduled driver (e.g., overall driver performance, driver efficiency at particular pickup/drop-off points, etc.). In this example, the ETA model may estimate that the predicted inclement weather will delay the delivery of load 3 by an hour and 30 minutes (estimating the final delivery for load 3 to be 5:30 p.m.). As such, the delivery schedule is still compliant, as load 3 is predicted to arrive within the delivery window for load 3 (3:00-9:00 p.m.). However, the OTP metric may indicate that the chances for an on-time delivery may be only 60 percent. In examples, this may be caused by accounting for the hours of service information for the driver. For example, if the inclement weather further delays the driver by an additional forty-five minutes (to 6:15 p.m. for final delivery of load 3), even though load 3 could still be delivered well within the delivery window for load 3, the driver would be outside of his/her permitted hours of service. In examples, a user may be provided one or more options to de-risk the shipment of load 3, as discussed further herein, to increase the OTP for load 3 (e.g., adding a co-driver or different driver for the final leg).

In some examples, external data may be updated on a continual or periodic basis during the trip. For example, the predicted weather and/or traffic information, as well as the actual position of the unit, may be updated in substantially real time, and the ETA and OTP for a particular load may be accordingly updated during a trip.

When the ETA and/or OTP for a load is produced by the applicable model(s), the ETA and/or OTP may be output on output queue 314. For example, the ETA/OTP may be output to client device 116 (e.g., via ESB 112), where it may be displayed and/or presented for approval by a user.

In some examples, the inference system 106B may return an initial ETA and/or OTP; however, the inference system 106B may be requested to provide an updated ETA and/or OTP based on changes to certain scheduling information or other user input. For example, as discussed, the ETA/OTP request may be routed from the optimization system 104, which is seeking one or more accurate ETA and/or OTP to use in generating or validating a proposed delivery schedule. However, based on returning the ETA and/or OTP, the delivery schedule produced by the optimization system 104 may be changed, either by a user or automatically/programmatically. Accordingly, the ETA/OTP system 106 may be requested to provide updated ETA(s)/OTP(s) based on updated scheduling information (such as an updated delivery schedule, updated unit information, updated route information, updated external data such as a change in weather, etc.).

Further, as mentioned, the first ETA and/or OTP for a load may be provided to a client device 116 (or other consumer of the service), either in conjunction with an initial delivery schedule produced by optimization system 104 or otherwise. In examples, a customer may receive a notification, e.g., at client device 116, that its load(s) will be delivered by a particular unit and/or along a particular assigned route. The ETA/OTP system 106 may also calculate and deliver an OTP for the load(s) based on such assignments in the initial delivery schedule. The customer may, either along with the notification of the first ETA and/or OTP or upon specific request, be electronically provided with one or more option(s) to de-risk the shipment of the load(s) by, e.g., submitting requested change(s) to the carrier information, the delivery schedule, or otherwise. As such, the optimization system 104 may be requested to recalculate an updated delivery schedule accordingly.

In examples, one or more options to de-risk a shipment may be presented in a user interface at a client device 116. For example, ETA/OTP system 106 may expose de-risking options through ESB 112 to an application operating on client device 116. The options to de-risk a shipment may, in examples, include providing a user one or more options to (a) change a target delivery date; (b) change assigned delivery equipment; (c) change a scheduled carrier for the load (if a shipper user has multiple carrier options); (d) add a co-driver to a scheduled delivery route; or make any other changes to scheduled delivery data or preferences that would affect the ETA and/or OTP. Other de-risking options are possible and contemplated. In examples, the de-risking options may be caused to be presented at client device(s) 116 by ETA/OTP system 106 along with the first ETA and/or OTP that is provided based on the initial delivery schedule. In examples, the de-risking options may be displayed with, among other things and for each de-risking option: an alternative estimated delivery time (alternative ETA); an alternative OTP metric; and a cost, if any, to the customer in order to select the de-risking option.

In examples where the ETA/OTP system receives scheduled delivery data from optimization system 104, in order to facilitate the ETA/OTP system 106 producing an alternative ETA and/or an alternative OTP for a given load, the optimization system 104 may provide to the ETA/OTP system 106 current scheduled delivery data for the load and at least one set of alternative scheduled delivery data for the load. The alternative scheduled delivery data may include alternative carrier data (such as alternative available carrier, alternative available delivery equipment, alternative available driver, an option to eliminate one or more stops on a route (for less critical loads), etc.). For example, the alternative scheduled delivery data may not be initially chosen as preferred by the optimization system 104 due to additional cost, additional deadhead miles for the delivery schedule overall, etc.; however, the alternative scheduled delivery data may be palatable to the customer based on an increased charge for delivery, the importance of a particular load, etc. The ETA/OTP system 106 can then calculate one or more alternative ETA and/or OTP for the load (based on the one or more set(s) of alternative scheduled delivery data) and cause such alternative ETA/OTP to be presented (e.g., to client device 116), along with the option to change the scheduled delivery data in order to de-risk the shipment. In other examples, alternative ETA/OTP for the different de-risking options may be presented only after request by the user.

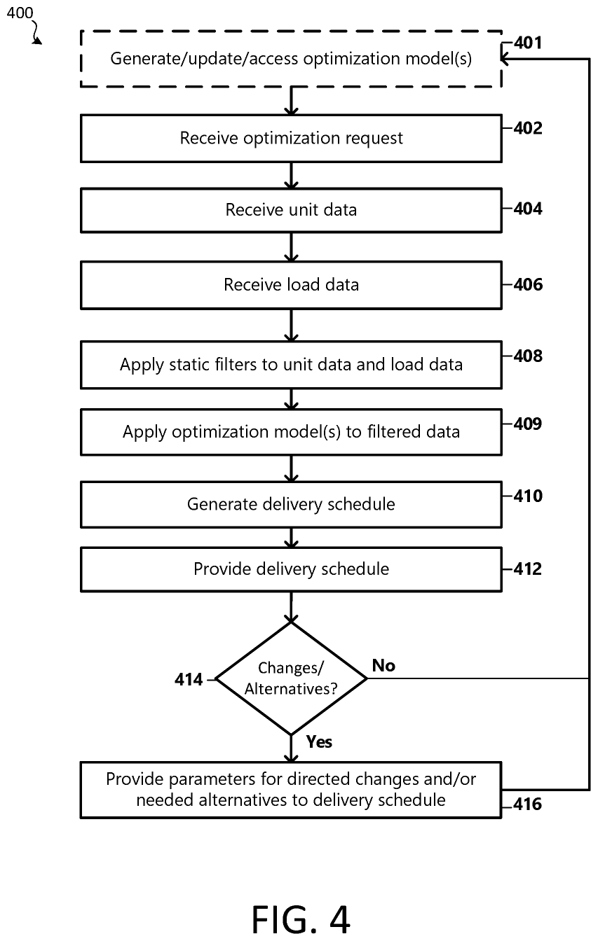

FIG. 4 illustrates an example method 400 for producing a delivery schedule according to aspects of the present application. In examples, one or more of the operations of method 400 may occur asynchronously and/or in a different order than shown. In examples, method 400 may be performed by optimization system 104. At operation 401, one or more optimization models may be generated, updated, and/or accessed. In examples, optimization model(s) may be created by optimization system 104. As discussed, optimization system 104 may include model generator system(s) 206 that are configured to generate optimization model(s). In other examples, optimization system 104 may access optimization model(s) from one or more other systems, such as a third-party system or remote storage. In addition, in examples, optimization model(s) may be continually or periodically educated with labeled past decisions data. For example, optimization model(s) may continually or periodically ingest additional past decisions data in order to continue to improve the optimization model(s). In examples, operation 401 is optional, as one or more valid optimization model(s) may have already been loaded and/or stored in optimization model(s) system 208. In examples, the optimization model(s) may be universal to all of the customers of TLS 102.

At operation 402, an optimization request is received. In examples, the optimization request may comprise a request to generate a delivery schedule that optimizes the matching of the customer's units and loads in order to minimize deadhead miles and/or maximize driver usage. In examples, the request may be received by the inference system 104B via input queue 212. For example, a client device 116 may include a user-interface that permits a user to submit an optimization request via ESB 112, which optimization request may be received by inference system 104B. For example, the inference system 104B may receive an optimization request 210 on input queue 212. In some examples, the optimization request may be automatically and/or periodically generated by an application on client device 116 or as programmed into optimization system 104. In other examples, a client device 116 may include a user-interface that permits a user to submit an optimization schedule for all of the customer's loads through ESB 112, which optimization request may be received by inference system 104B. In examples where TLS 102 provides services to multiple customers, the request may identify a particular customer for which optimization has been requested.

In examples, the optimization request may contain additional information, such as: a request type (e.g., whether the request is for scheduling a single delivery, for scheduling all loads of a particular customer, for scheduling an entire fleet of units, etc.); and a time range (such as a time period for all of the loads/units to be scheduled pursuant to the request). In addition, the request may include (or cause creation of) several data matrices describing the relative locations of, and distances between and among, units and loads. In examples, such distance matrices may be generated by one or more components of system 102 from unit data and load data in unit storage system 124 and load storage system 126, or may be received from an external data source, such as external data system(s) 122.

At operations 404 and 406, unit data and load data are obtained. For example, the inference system 104B may receive, unit data and load data, as previously described. In examples, unit data and load data may be obtained based on parameters associated with the optimization request, such as the scope of the delivery schedule requested (e.g., which carriers/units, time frame, which shippers/loads, etc.).

At operation 408, static filters may then be applied to the unit data and load data. In examples, the unit data and load data may be filtered by static filter chains system 110, as previously described, prior to being provided to inference system 1046. For example, data filters may be defined that do not depend on unit or load location. In examples, these may include: LoadType Filter—checks if the type of unassigned load matches the delivery equipment properties; WeightFilter—checks if the weight of the load does not exceed the maximum permitted weight assigned to the unit; VolumeFilter—checks if the load volume does not exceed the maximum volume assigned to the unit; and HazardousFilter—checks if the unit has license for the hazardous material transport and that it will not expire before completion of delivery. Other filters are possible and contemplated. Static filters, in examples, may be applied to unit data and load data before filtered unit data and load data are then provided to optimization model(s) system 208.

At operation 409, one or more optimization model(s) are applied to the filtered unit data, load data, and (in some cases) external data. For example, the filtered unit data and load data may be fed to optimization model(s) system 208, where the optimization model(s) may be applied. As discussed, the optimization model(s) may, in examples, be based on a holistic annealing algorithm, a linear programming algorithm, or otherwise. In examples, the model(s) may be recursively applied to the unit data and load data in order to arrive at a best solution for the delivery schedule. In some examples, defined constraints may also be enforced in applying the optimization model(s). In examples, some constraints may be configurable by a customer, e.g., using a user interface displayed on client device 116. In some examples, some constraints may be included in each optimization request. In other examples, some constraints may be stored in a configuration file for the customer, e.g., at configuration system 108. For example, one defined constraint may include that each load must be delivered (or have an ETA) inside of its defined delivery window. In other examples, a constraint may allow loads to be delivered late but may assign a deadhead-equivalence penalty for scheduled late delivery. In examples, this may allow the model(s) to balance the benefit of deadhead miles avoidance with, e.g., any consequence(s) of late delivery. Another constraint may be a customer-defined tolerance for the total deadhead miles (for a certain period of time) for all units. In some examples, if a tolerance for total deadhead miles would otherwise be exceeded, it may result in one or more loads not being matched with a unit in an initial delivery schedule. A customer may then choose to increase the total deadhead miles tolerance constraint in order to allow all loads to be matched with a unit or submit one or more other requests to change the initial delivery schedule, as discussed herein.

At operation 410, a delivery schedule may be generated. In examples, the final delivery schedule is generated by optimization model(s) system 208 via application of the optimization model(s), as described. In some examples, generating the delivery schedule may include requesting (or receiving) an ETA for one or more proposed route(s) in the delivery schedule from an ETA system, such as ETA/OTP system 106, or a third-party system.

At operation 412, the delivery schedule may be provided. For example, the delivery schedule may be provided to a client device 116 for display and/or approval. In other examples, the delivery schedule (or one or more portions of the delivery schedule for particular load(s)) may be provided to ETA/OTP system 106 or a third-party ETA/OTP system. In other examples, the delivery schedule (or one or more portions of the delivery schedule for particular load(s)) may be provided to a client device 116. In still other examples, the delivery schedule (or one or more portions of the delivery schedule for particular load(s)) may be provided to one or more pieces of delivery equipment 120. For example, the delivery schedule (or one or more portions of the delivery schedule for particular load(s)) may be provided to navigation system(s) of truck(s), including causing one or more autonomous vehicles to automatically pickup and deliver certain assigned loads according to the first delivery schedule.

At operation 414, a determination is made whether any changes have been received that would affect the delivery schedule and/or whether any alternatives for one or more portion(s) of the delivery schedule are required.

For example, as discussed, the delivery schedule may be sent to one or more client device(s) 116 for approval. In some instances, a customer may not accept the first delivery schedule and may request particular changes (e.g., that a particular load be matched with a particular unit). In other examples, as discussed, the first delivery schedule (or one or more portions of the delivery schedule for particular load(s)) may be provided to ETA/OTP system 106. The ETA/OTP system 106 may provide an ETA and/or OTP to a user or client application (such as at client device 116), and options to de-risk the shipment may also be provided. In some examples, the inference system 104B may need to provide multiple options for the delivery schedule (including, e.g., different options for matching loads to units, different driver options, different routing options for a particular load, etc.) in order for the ETA/OTP system to provide shipment de-risking options to a customer. Further, after receiving de-risking options, the customer may choose to select one such option, which will cause a change to the first delivery schedule.

Since any of these changes to one portion of the first delivery schedule may affect other portions of the first delivery schedule, the change information may need to be provided to the inference system 104B so that the entire delivery schedule (e.g., a revised delivery schedule) may be calculated. As such, if any of the foregoing are true, or the optimization system 104 receives any other directed changes to the first delivery schedule, flow branches yes from operation 414 to operation 416, where the parameters of the change (or needed schedule alternatives) are provided. For example, the parameters of the change (or needed schedule alternatives) may be provided to inference system 1046. Flow then proceeds back to operation 401, where the process is repeated, however, the parameters for the changes to the first delivery schedule may be used as constraints in subsequent iterations of method 400 in order to generate a revised delivery schedule that accounts for the requested change(s). In examples, the revised delivery schedule may attempt to minimize the overall deadhead miles in the system 100 and/or maximize driver usage, to the extent possible while still accounting for the requested change(s).

In some instances, the first delivery schedule may be approved (and or no changes may have been received within a present period of time), and flow from operation 414 will branch no to operation 401, where the process may be repeated for additional optimization request(s).

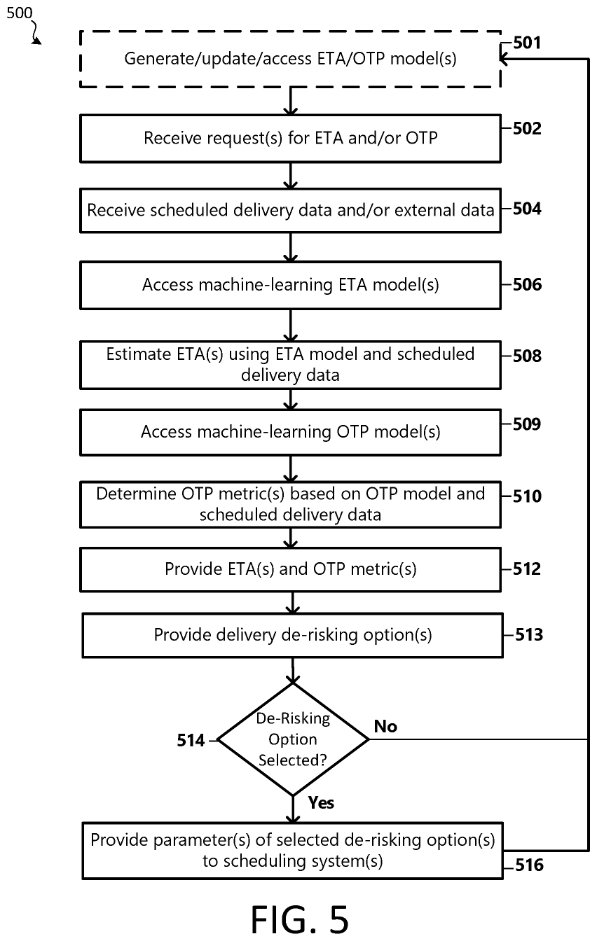

FIG. 5 depicts an example method 500 for generating an ETA and/or an OTP for one or more load(s). In examples, one or more of the operations of method 500 may occur asynchronously and/or in a different order than shown. At operation 501, one or more ETA/OTP models may be generated, updated, and/or accessed. In examples, ETA/OTP model(s) may be created by ETA/OTP system 106. As discussed, ETA/OTP system 106 may include model generator system(s) 306 that are configured to generate ETA/OTP model(s) based on historical data. In other examples, ETA/OTP system 106 may access ETA/OTP model(s) from one or more other systems, such as a third-party system or remote storage. In addition, in examples, ETA/OTP model(s) may be continually updated. For example, ETA/OTP model(s) may continually or periodically ingest additional historical data as the model(s) are being used in order to continue to refine ETA/OTP model(s). In examples, operation 501 is optional, as one or more valid ETA/OTP model(s) may have already been loaded and/or stored in ETA/OTP model(s) system 308. In examples, the ETA/OTP model(s) may be universal to a plurality of carrier(s) and/or to a plurality of shipper(s), such as all of the customers of TLS 102.

At operation 502, one or more request(s) for ETA and/or OTP may be received. Request(s) for ETA/OTP may be received at inference system 106B, for example, from optimization system 104, from a client device 116, or from another system. In examples, the optimization system 104 may request ETA/OTP for load(s) and unit(s) combinations and potential route(s) during the generation of a delivery schedule. In other examples, the optimization system 104 may request one or more ETA(s)/OTP(s) for particular load(s) whenever a delivery schedule is produced by the optimization system 104. In some examples, as discussed, the optimization system 104 may provide multiple ETA/OTP requests for a single load based on alternative potential routes or units. In other examples, a customer may make an ETA/OTP request independent of the optimization system 104, e.g., through ESB 112.

At operation 504, scheduled delivery data is received. In examples, the scheduled delivery data is part of the ETA request. In other examples, the delivery request may include certain identifying information for a load, and the receipt of the request may prompt the ETA/OTP system 104 to obtain additional scheduled delivery data. In examples, the scheduled delivery data may include, for a first load, at least carrier data and load data. The load data may comprise load identifying information, a load start location, and a load end location. Load data may also include a delivery window for the load. In addition, in examples, carrier data may include: identification of a scheduled carrier for the load (if a customer is querying ETA/OTP for multiple carriers), identification of currently scheduled delivery equipment, scheduled driver(s), a number of scheduled stops for the currently scheduled delivery equipment, a location of stops for the currently scheduled delivery equipment, and/or driver hours of service information. In addition, the ETA/OTP system 104 may also obtain data from external data sources, such as external data system(s) 122. External data may include, for example, route data, weather data, distance data, etc.

At operation 506, a machine-learning ETA model is accessed. For example, the inference system 106B may include a request classifier 312 that separates ETA requests between carrier requests and shipper requests in order to access the correct (carrier or shipper) model. In some examples, the model(s) may be further specific to a particular carrier or a particular shipper that is identified in the ETA request(s). In other examples, only one ETA model is used for all customers of the TLS 102.

At operation 508, ETA(s) for the load(s) is/are estimated based on the accessed model(s), scheduled delivery data, and any relevant external data. For example, the scheduled delivery data and/or any external data may be fed to ETA model(s) system 308, where the accessed/applicable ETA model(s) may be applied in order to produce ETA(s) for the applicable load(s). In some examples, the external data may include an initial ETA that was calculated by a third-party service, e.g., based on simple distance measurements and/or traffic/routing information, and the estimation of operation 508 may produce a refined ETA based on the accessed model(s). As discussed, the model(s) may be applied, in examples, to scheduled delivery data for several alternatives for a single load so that ETA(s) for each such alternative may be provided in the de-risking option(s) presented, e.g., to a user.

At operation 509, a machine-learning OTP model is accessed. For example, the inference system 106B may include a request classifier 312 that separates OTP requests between carrier requests and shipper requests in order to access the correct (carrier or shipper) model. In some examples, the model(s) may be further specific to a particular carrier or a particular shipper that is identified in the ETA and/or OTP request(s). In other examples, only one OTP model is used for all customers of the TLS 102.

At operation 510, one or more OTP metric(s) are determined based on the accessed/applicable OTP model(s), scheduled delivery data, and any applicable external data. For example, OTP metric(s) for the load(s) is/are estimated based on the accessed model(s), scheduled delivery window(s) the load(s), the scheduled delivery data, and any relevant external data. For example, the scheduled delivery data and/or any external data may be fed to OTP model(s) system 308, where the accessed/applicable OTP model(s) may be applied in order to produce OTP metric(s) for the applicable load(s). As discussed, the model(s) may be applied, in examples, to scheduled delivery data for several alternatives for a single load so that OTP metric(s) for each such alternative may be provided in the de-risking option(s) presented, e.g., to a user.

At operation 512, one or more ETA(s) and/or OTP(s) are provided. For example, the ETA(s)/OTP(s) may be provided to a client device 116 for display and/or approval. In other examples, the ETA(s)/OTP(s) may be provided to optimization system 104 or a third-party optimization system. In other examples, the ETA(s)/OTP(s) (or one or more portions of the ETA(s)/OTP(s) for particular load(s)) may be provided to a client device 116. In still other examples, the ETA(s)/OTP(s) (or one or more portions of the delivery schedule for particular load(s)) may be provided to one or more pieces of delivery equipment 120.

In examples, the ETA(s)/OTP(s) may be provided along with, at operation 513, shipment de-risking options. For example, as discussed, one or more options to de-risk a shipment may be sent to a client device 116 to be presented in a user interface at a client device 116. For example, ETA/OTP system 106 may expose de-risking options through ESB 112 to an application operating on client device 116. The options to de-risk a shipment may, in examples, include providing a customer one or more options to (a) change a target delivery date; (b) change assigned delivery equipment; (c) change a scheduled carrier for the load; (d) add a co-driver to a scheduled delivery route; or make any other changes to scheduled delivery data or customer preferences that would affect the ETA and/or OTP. In examples, the de-risking options may be caused to be presented at client device(s) 116 by ETA/OTP system 106 along with the first ETA and/or OTP that is provided based on the initially scheduled delivery schedule. In examples, the de-risking options may be displayed with, among other things and for each de-risking option: an alternative estimated delivery time (alternative ETA); an alternative OTP metric; and a cost, if any, to the customer in order to select the de-risking option.

At operation 514, it is determined if any de-risking options have been selected. If so, flow branches yes and proceeds to operation 516, where parameters of the de-risking option(s) may be sent to an optimization system. For example, if a user has selected a de-risking option that causes a change of delivery data or delivery equipment, the parameters of that change may be returned to optimization system 104, which may recalculate a delivery schedule, as previously described. After or in parallel with operation 516, flow proceeds back to operation 501, where the method 500 may be repeated. If no de-risking option is selected, flow branches from operation 514 back to operation 501, where one or more of the operations of the method 500 may be repeated (in the same or a different order).

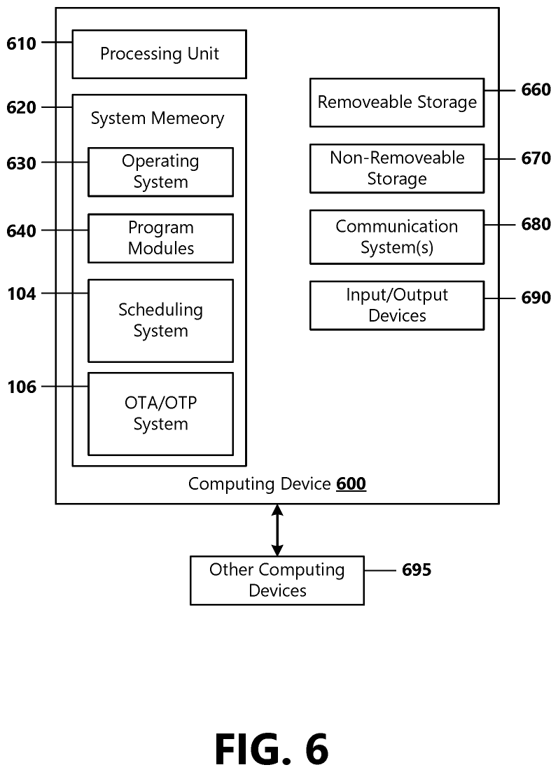

FIG. 6 is a block diagram illustrating physical components of an example computing device 600 with which aspects may be practiced. In examples, computing device 600 may comprise or enable one or more of the components described with respect to the system 100 in FIG. 1. The computing device 600 may include at least one processing unit 602 and a system memory 604. The system memory 604 may comprise, but is not limited to, volatile (e.g. random access memory (RAM)), non-volatile (e.g. read-only memory (ROM)), flash memory, or any combination thereof. System memory 604 may include operating system 606, one or more program instructions 608, and may include sufficient computer-executable instructions for the optimization system 104 and/or the ETA/OTP system 106, which when executed, perform functionalities as described herein. Operating system 606, for example, may be suitable for controlling the operation of computing device 600. Furthermore, aspects may be practiced in conjunction with a graphics library, other operating systems, or any other application program and is not limited to any particular application or system. This basic configuration is illustrated by those components within a dashed line 610. Computing device 600 may also include one or more input device(s) 612 (keyboard, mouse, pen, touch input device, etc.) and one or more output device(s) 614 (e.g., display, speakers, a printer, etc.).

The computing device 600 may also include additional data storage devices (removable or non-removable) such as, for example, magnetic disks, optical disks, or tape. Such additional storage is illustrated by a removable storage 616 and a non-removable storage 618. Computing device 600 may also contain a communication connection 620 that may allow computing device 600 to communicate with other computing devices 622, such as over a network in a distributed computing environment, for example, an intranet or the Internet. Communication connection 620 is one example of a communication medium, via which computer-readable transmission media (i.e., signals) may be propagated.

Programming modules may include routines, programs, components, data structures, and other types of structures that may perform particular tasks or that may implement particular abstract data types. Moreover, aspects may be practiced with other computer system configurations, including hand-held devices, multiprocessor systems, microprocessor-based or programmable user electronics, minicomputers, mainframe computers, and the like. Aspects may also be practiced in distributed computing environments where tasks are performed by remote processing devices that are linked through a communications network. In a distributed computing environment, programming modules may be located in both local and remote memory storage devices.

Furthermore, aspects may be practiced in an electrical circuit comprising discrete electronic elements, packaged or integrated electronic chips containing logic gates, a circuit using a microprocessor, or on a single chip containing electronic elements or microprocessors (e.g., a system-on-a-chip (SoC)). Aspects may also be practiced using other technologies capable of performing logical operations such as, for example, AND, OR, and NOT, including, but not limited to, mechanical, optical, fluidic, and quantum technologies. In addition, aspects may be practiced within a general purpose computer or in any other circuits or systems.

Aspects may be implemented as a computer process (method), a computing system, or as an article of manufacture, such as a computer program product or computer-readable storage medium. The computer program product may be a computer storage medium readable by a computer system and encoding a computer program of instructions for executing a computer process. Accordingly, hardware or software (including firmware, resident software, micro-code, etc.) may provide aspects discussed herein. Aspects may take the form of a computer program product on a computer-usable or computer-readable storage medium having computer-usable or computer-readable program code embodied in the medium for use by, or in connection with, an instruction execution system.

Although aspects have been described as being associated with data stored in memory and other storage mediums, data can also be stored on or read from other types of computer-readable media, such as secondary storage devices, like hard disks, floppy disks, flash drives, or a CD-ROM, or other forms of RAM or ROM. The term computer-readable storage medium refers only to devices and articles of manufacture that store data or computer-executable instructions readable by a computing device. The term computer-readable storage media does not include computer-readable transmission media.

Aspects of the present invention may be used in various distributed computing environments where tasks are performed by remote processing devices that are linked through a communications network.

Aspects of the invention may be implemented via local and remote computing and data storage systems. Such memory storage and processing units may be implemented in a computing device. Any suitable combination of hardware, software, or firmware may be used to implement the memory storage and processing unit. For example, the memory storage and processing unit may be implemented with computing device 600 or any other computing devices 622, in combination with computing device 600, wherein functionality may be brought together over a network in a distributed computing environment, for example, an intranet or the Internet, to perform the functions as described herein. For example, some or all of the systems described herein may be implemented as services hosted in a cloud computing environment. The systems, devices, and processors described herein are provided as examples; however, other systems, devices, and processors may comprise the aforementioned memory storage and processing unit, consistent with the described aspects.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more aspects provided in this application are intended to provide a thorough and complete disclosure of the full scope of the subject matter to those skilled in the art and are not intended to limit or restrict the scope of the invention as claimed in any way. The aspects, examples, and details provided in this application are considered sufficient to convey possession and enable those skilled in the art to practice the best mode of the claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, aspects, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of the present application, one skilled in the art may envision variations, modifications, and alternate embodiments falling within the spirit of the broader aspects of the general inventive concept provided in this application that do not depart from the broader scope of the present disclosure.

What is claimed is:

1. A method, comprising:
receiving a request for an estimated-time-of-arrival (ETA) for a first load;
receiving scheduled delivery data, wherein the scheduled delivery data includes, for the first load, at least carrier data, first load data, and external data, the first carrier data comprising at least driver information and driver hours of service information, the first load data comprising first load identifying information, a first load start location, and a first load end location, and the external data comprising at least traffic data and weather data;
accessing a machine-learning, ETA model;
estimating, using the ETA model and the scheduled delivery data, a first estimated delivery time for the first load; and
providing the first estimated delivery time.

2. The method of claim 1, further comprising:
accessing an on-time-probability (OTP) model;
determining, based on the OTP model and the scheduled delivery data, a first estimated on-time probability (OTP) metric for the first load; and
providing the first estimated on-time probability metric, wherein the first estimated on-time probability metric comprises an estimated chance for the first load to be delivered within a delivery window.

3. The method of claim 1, further comprising:
receiving an initial estimated delivery time for the first load;
wherein estimating the first estimated delivery time for the first load comprises revising the initial estimated delivery time based on the scheduled delivery data and the ETA model.

4. The method of claim 3, wherein the carrier data further comprises at least one of:
identification of currently scheduled delivery equipment, a number of scheduled stops for the currently scheduled delivery equipment, or a location of stops for the currently scheduled delivery equipment.

5. The method of claim 2, further comprising:
providing, to a client device, at least one option to improve the first estimated on-time performance metric;
receiving a selection of the at least one option;
alerting an optimization system of the selection of the at least one option.

6. The method of claim 5, wherein:
the carrier data further comprises at least one of: identification of currently scheduled delivery equipment, identification of currently scheduled stops for the currently scheduled delivery equipment, or driver hours of service information; and
the at least one option comprises altering the carrier data.

7. The method of claim 6, wherein:
the scheduled delivery data includes carrier data for a currently scheduled delivery of the first load and alternative carrier data;
the at least one option comprises altering the carrier data by choosing the alternative carrier data; and
wherein the method further comprises providing, to the client device, at least one of an alternative first estimated delivery time or an alternative first estimated on-time probability metric using the alternative carrier data.

8. The method of claim 7, wherein providing the at least one of an alternative first estimated delivery time or an alternative first estimated on-time probability metric occurs prior to receiving the selection of the at least one option.

9. The method of claim 7, further comprising:
receiving at least one of an updated ETA model or updated scheduled delivery data;
updating, based on the updated ETA model or updated scheduled delivery data, the first estimated delivery time, the first estimated on-time performance metric, and at least one of the alternative first estimated delivery time or the alternative first estimated on-time performance metric.

10. The method of claim 7, wherein altering the carrier data by choosing the alternative carrier data automatically causes at least one autonomous vehicle to deliver the first load to the first load end location.

11. A system, comprising:
at least one processor; and
memory, operatively connected to the at least one processor and storing instructions that, when executed by the at least one processor, cause the system to perform a method, the method comprising:
receiving a request for an estimated-time-of-arrival (ETA) for a first load;
receiving scheduled delivery data, wherein the scheduled delivery data includes, for the first load, at least carrier data, first load data, and external data, the first carrier data comprising at least driver information and driver hours of service information, the first load data comprising first load identifying information, a first load start location, and a first load end location, and the external data comprising at least traffic data and weather data;
accessing a machine-learning, ETA model;
estimating, using the ETA model and the scheduled delivery data, a first estimated delivery time for the first load; and
providing the first estimated delivery time.

12. The system of claim 11, wherein the method further comprises:
accessing an on-time-probability (OTP) model;
determining, based on the OTP model and the scheduled delivery data, a first estimated on-time probability (OTP) metric for the first load;
providing the first estimated on-time probability metric, wherein the first estimated on-time probability metric comprises an estimated chance for the first load to be delivered within a delivery window.

13. The system of claim 11, wherein the method further comprises:
receiving an initial estimated delivery time for the first load;
wherein estimating the first estimated delivery time for the first load comprises revising the initial estimated delivery time based on the scheduled delivery data and the ETA model.

14. The system of claim 13, wherein the carrier data further comprises at least one of: identification of currently scheduled delivery equipment, a number of scheduled stops for the currently scheduled delivery equipment, or a location of stops for the currently scheduled delivery equipment.

15. The system of claim 12, wherein the method further comprises:
providing, to a client device, at least one option to improve the first estimated on-time performance metric;
receiving a selection of the at least one option;
alerting an optimization system of the selection of the at least one option.

16. The system of claim 15, wherein:
the carrier data further comprises at least one of: identification of currently scheduled delivery equipment, or identification of currently scheduled stops for the currently scheduled delivery equipment; and
the at least one option comprises altering the carrier data.

17. The system of claim 16, wherein:
the scheduled delivery data includes carrier data for a currently scheduled delivery of the first load and alternative carrier data;
the at least one option comprises altering the carrier data by choosing the alternative carrier data; and
wherein the method further comprises providing, to the client device, at least one of an alternative first estimated delivery time or an alternative first estimated on-time probability metric using the alternative carrier data.

18. The system of claim 17, wherein the method further comprises:
receiving at least one of an updated ETA model or updated scheduled delivery data;
updating, based on the updated ETA model or updated scheduled delivery data, the first estimated delivery time, the first estimated on-time performance metric, and at least one of the alternative first estimated delivery time or the alternative first estimated on-time performance metric.

19. The system of claim 17, wherein altering the carrier data by choosing the alternative carrier data automatically causes at least one autonomous vehicle to deliver the first load to the first load end location.

20. A method, comprising:
receiving a request for an estimated-time-of-arrival (ETA) for a first load;
receiving scheduled delivery data, wherein the scheduled delivery data includes, for the first load, at least carrier data, first load data, and external data, the first carrier data comprising at least driver information and driver hours of service information, the first load data comprising first load identifying information, a first load start location, and a first load end location, and the external data comprising at least traffic data and weather data;
accessing a machine-learning, ETA model;
estimating, using the ETA model and the scheduled delivery data, a first estimated delivery time for the first load;
providing the first estimated delivery time;
accessing an on-time-probability (OTP) model;
determining, based on the OTP model and the scheduled delivery data, a first estimated on-time probability (OTP) metric for the first load;
providing the first estimated on-time probability metric, wherein the first estimated on-time probability metric comprises an estimated chance for the first load to be delivered within a delivery window;
providing, to a client device, at least one option to improve the first estimated on-time performance metric;
receiving a selection of the at least one option; and
alerting an optimization system of the selection of the at least one option.
